(19) United States
(12) Patent Application Publication
(10) Pub. No.: US 2012/0024331 A1
(43) Pub. Date: Feb. 2, 2012

(54) Canopy Assembled with Fastening Brackets

(76) Inventor: Lifeng Zhao, Ningbo (CN)

(21) Appl. No.: 12/846,384

(22) Filed: Jul. 29, 2010

(51) Int. Cl. E04H 15/34; B23P 11/00

(52) U.S. Cl. 135/121; 29/525.02

(57) ABSTRACT

The present invention uses special fastening brackets to assemble a canopy. The fastening brackets are uniquely shaped so it could bind the metal bars together without the need to drill holes through them, thereby causing the need to match the holes. Therefore, as the canopy changes its shapes as it is being used, the assembling would not be a problem.

### FIELD OF THE INVENTION

The present invention relates to a novel method to assemble canopies with fastening brackets.

### BACKGROUND OF THE INVENTION

Canopies are consisted of several columns and a cover. Traditionally, manufacturers of canopy struggle between the ease of assembling/disassembling and the sturdiness and stability of the canopy when assembled.

Collapsible canopies such as U.S. Pat. Nos. 4,641,676, 4,779,635, 5,511,572, 5,634,483, often face the problem of being too fragile. Sturdier designs, such as gazebos, face the problem of difficulties in assembling and transportation.

Traditionally, the structure bars of canopies are made of metal tubes. These tubes are connected by inserting one tube's end, with a outer diameter small enough to be inserted into the other tube, into the other. These canopies are typically unstable.

Another traditional method is to fasten parallel bars by drilling holes on both bars to allow fastening screws to pass through. The problem with this design is that the use of the canopy would cause its shape to change, resulting in difficulties to line up all the holes. The present invention resolved that problem by making it unnecessary to match the holes for the fastening screws to pass through.

The present invention attempts to improve upon those designs.

### SUMMARY OF THE INVENTION

The present invention, by adopting a novel method to assemble canopies with fastening brackets, offers a middle ground between traditional canopies and gazebos. It allows easy assembling and disassembling, while provide the sturdiness that often comes only with gazebos. The fastening brackets can be applied by inserting two bars into the brackets, turning the brackets 90 degrees, and fasten the screws on the fastening brackets. Since the fastening brackets can be applied at any location to join two adjoining metal bars without the need to match holes drilled on the bars, the method would prolong the usable lives of the canopy.

### BRIEF DESCRIPTION OF THE DRAWINGS

FIG. 1 The joining bracket

FIG. 2 Fastening bracket prior to inserting into the bars

FIG. 3 Fastening bracket inserted into the bars

FIG. 4 Fastening bracket being rotated

FIG. 5 Fastening bracket rotated in place

FIG. 6 Tightening the nut

FIG. 7 Fastening bracket installed

FIG. 8 Canopy with L shaped columns

FIG. 9 Canopy with L shaped columns with fastening brackets

FIG. 10 Assembled canopy

### DETAILED DESCRIPTION OF THE INVENTION

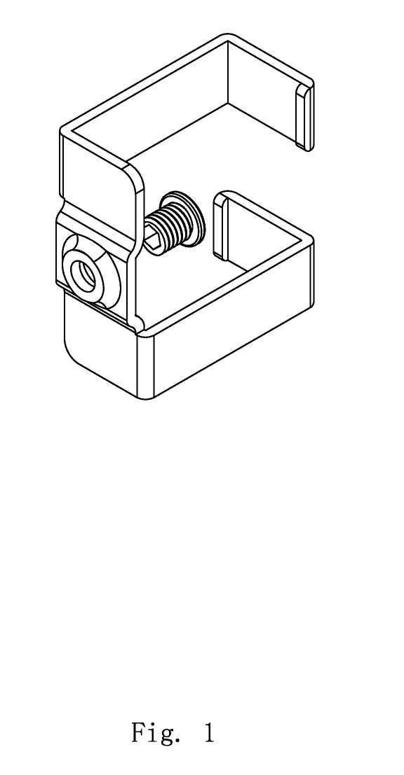

The present invention uses a fastening bracket (see FIG. 1) to fasten two parallel bars with rectangle shaped cross sections and equal width. The fastening bracket is composed of two U shaped brackets, with one facing up (1) and one facing down (2), connected on one side (3) with a threaded hole (4) for a fastening screw to tighten the grip of the bracket to the rectangle bars (see FIG. 1).

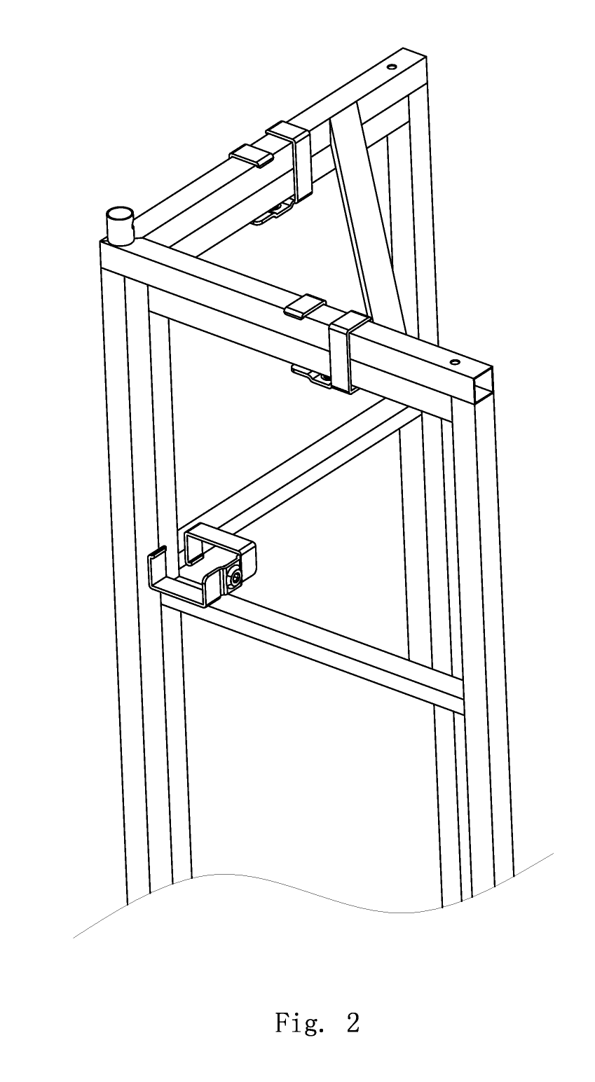

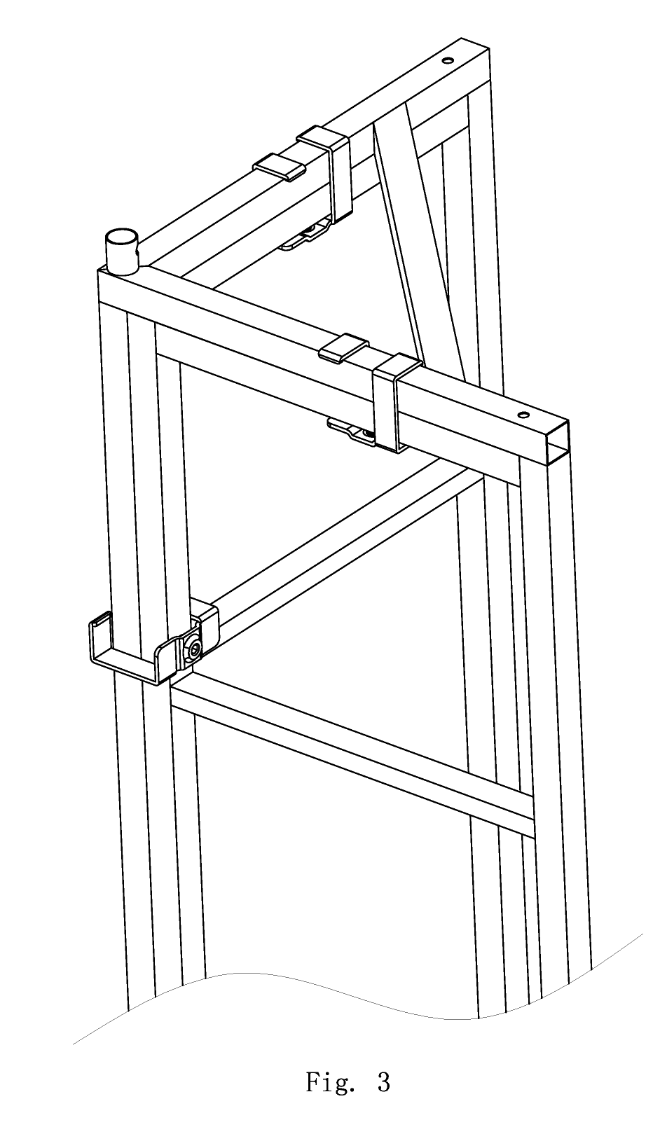

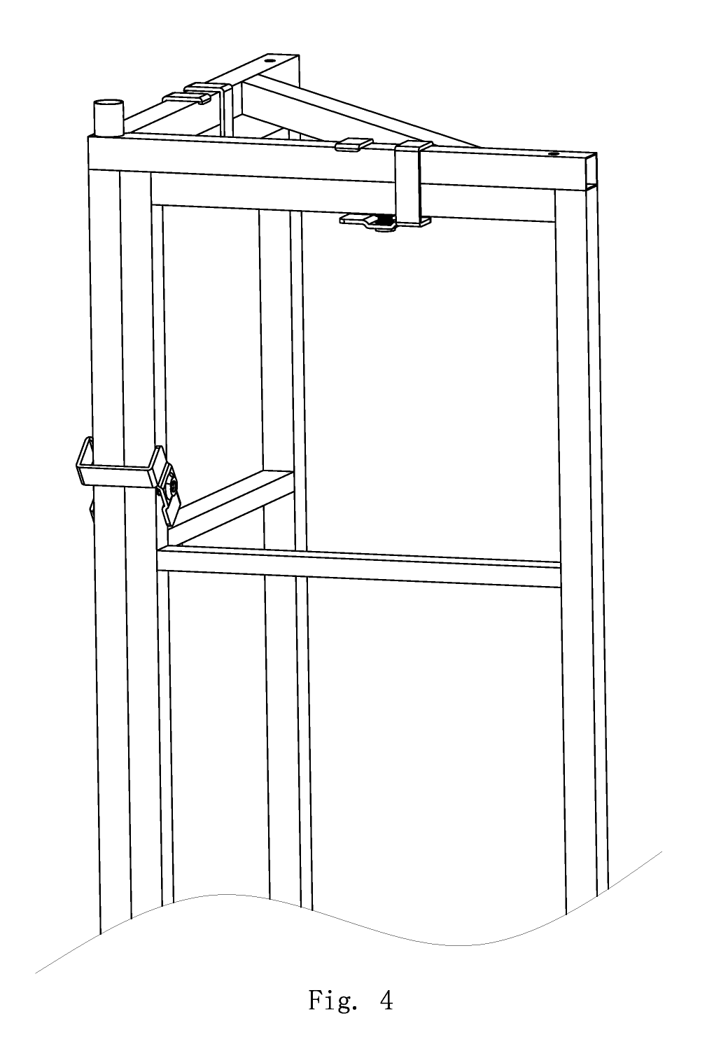

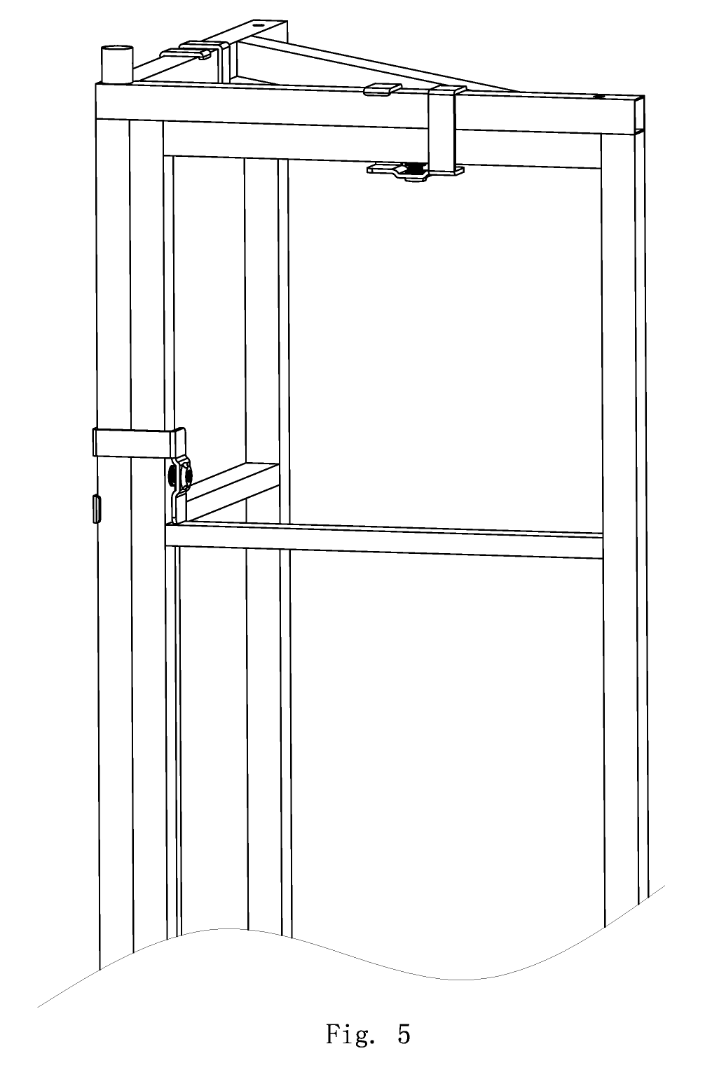

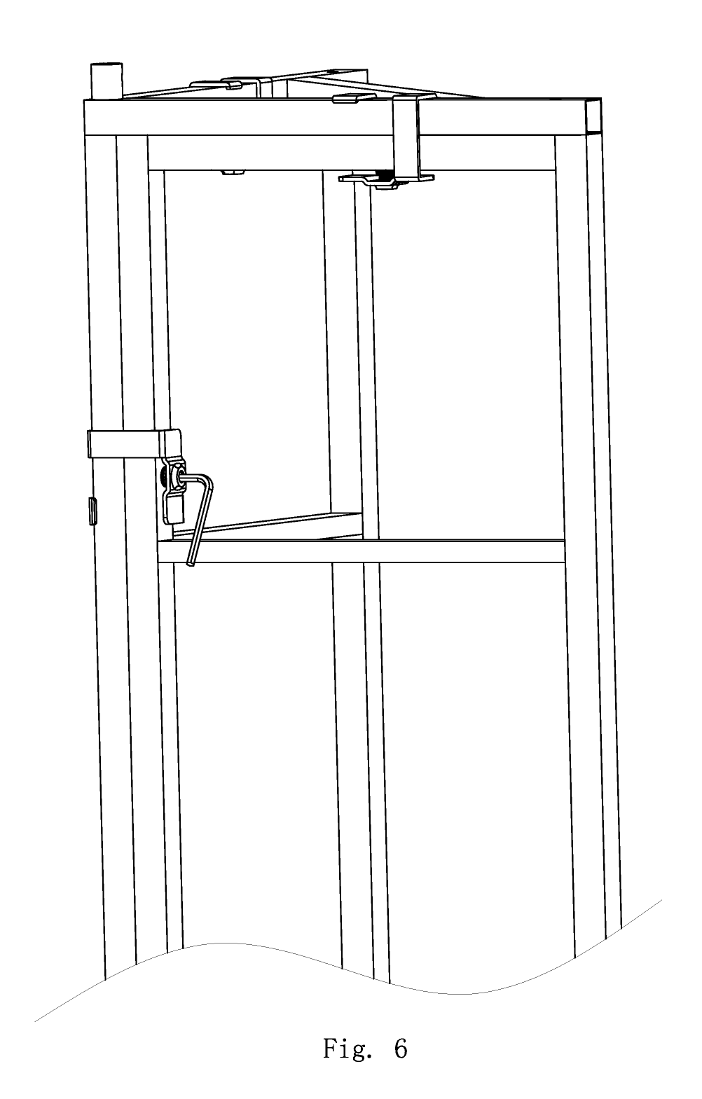

To use the bracket to fasten two rectangle bars, first, the two bars are inserted through the opening of the bracket (FIGS. 2 and 3). Second, the fastening bracket (see FIG. 4) is rotated ninety degrees until the two bars reach the bottom of the both U shaped parts of the fastening bracket (FIG. 5). Third, the nut is tightened (see FIG. 6).

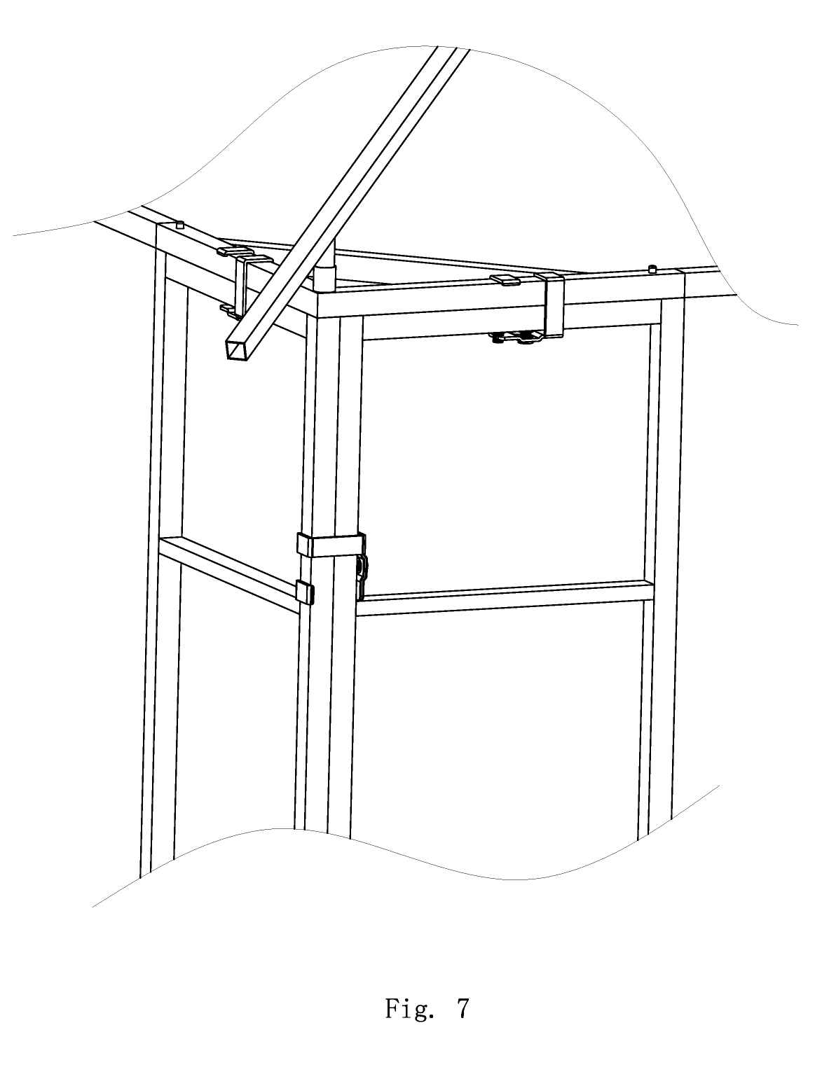

With this fastening method, columns of the canopy can be tightly fastened to the cover (FIG. 7).

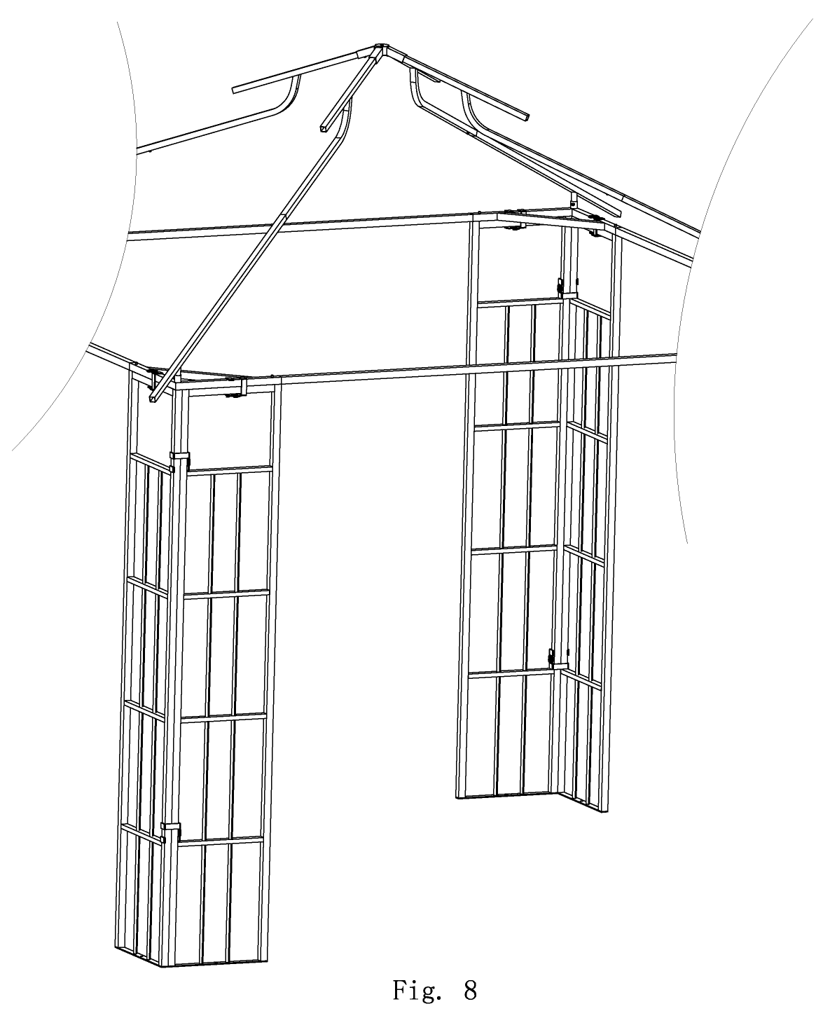

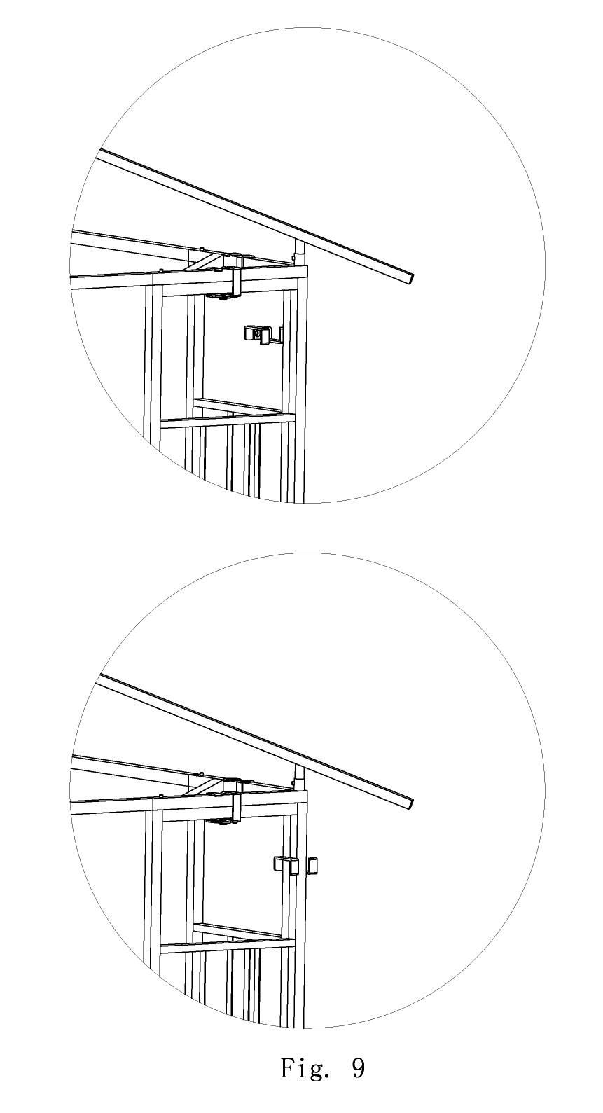

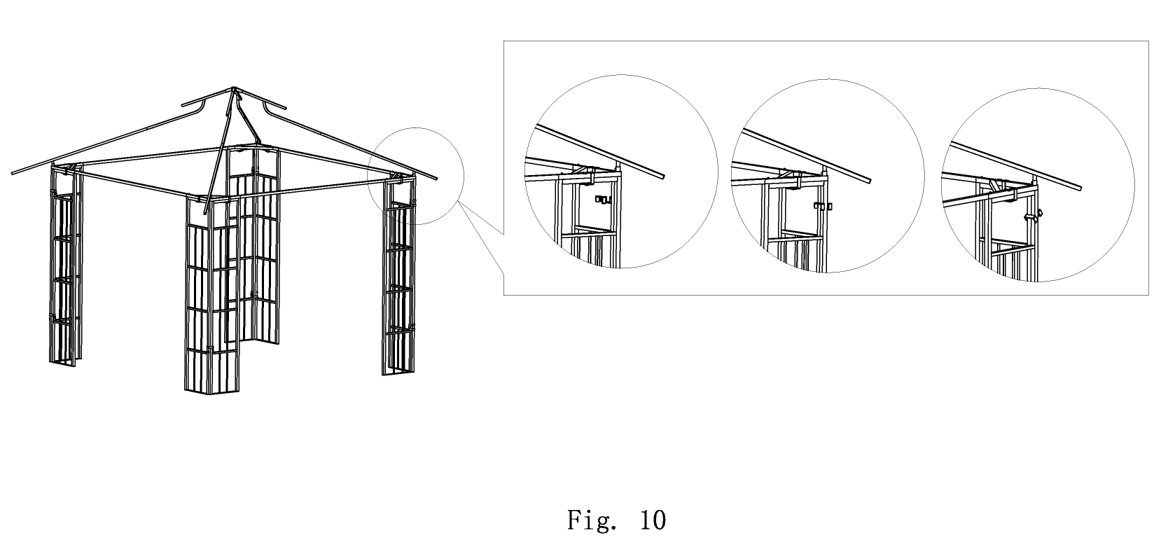

In one embodiment, four columns are made of L shaped frames (see FIG. 8), which are connected with the cover frames by the fastening bracket (see FIG. 9). The completed canopy is shown in FIG. 10.

What is claimed is:

1. A method of assembling a building structure by using a fastening bracket comprising a tightening nut and a bare bracket comprising two U shaped parts inversely placed with one side connected and the other side left open forming said bare bracket where the opening side allows two bars of different parts of the building structure to enter and, by rotating the fastening bracket 90 degrees, both U shaped parts will enclose both bars, and a threaded hole in the connecting part for the tightening nut to tighten both the U shaped portion's hold on the bars.

2. A building structure of claim 1 where canopy columns and canopy cover frame is made of metal.

3. A building structure of claim 2 where columns and the cover frame is made of steel.

4. A building structure of claim 1 where the fastening bracket has protruding lines on the inside that touches the bars to enhance the grasp of the bars.
